(19) United States
(12) Patent Application Publication
(10) Pub. No.: US 2008/0229206 A1
(43) Pub. Date: Sep. 18, 2008

(54) AUDIBLY ANNOUNCING USER INTERFACE ELEMENTS

(75) Inventors: Eric Taylor Seymour, San Jose, CA (US); Richard W. Fabrick, Campbell, CA (US); Patti Pei-Chin Hoa, Campbell, CA (US); Anthony E. Morales, Mountain View, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/686,295

(22) Filed: Mar. 14, 2007

(51) Int. Cl. G06F 3/16

(52) U.S. Cl. 715/727

(57) ABSTRACT

Systems, apparatus, methods and computer program products are described below for using surround sound to audibly describe the user interface elements of a graphical user interface. The position of each audible description is based on the position user interface element in the graphical user interface. A method is provided that includes identifying one or more user interface elements that have a position within a display space. Each identified user interface element is described in surround sound, where the sound of each description is positioned based on the position of each respective user interface element relative to the display space.

### TECHNICAL FIELD

This disclosure relates to presentation of information in an information system.

### BACKGROUND

Graphical user interfaces (GUIs) typically include a variety of interface elements including, for example, windows, buttons, input boxes, list boxes, labels, tool bars and icons. Generally a GUI is visually presented on a display device (e.g., a monitor or screen). Audibly announcing or reading the elements of a GUI can be helpful to users, particularly those who are visually impaired. Some conventional GUI systems such as Mac OS X® operating system from Apple Computer Inc. of Cupertino, Calif. or Microsoft Windows provide accessibility mechanisms to audibly announce the elements of a GUI currently being displayed.

Some conventional systems provide a visual cue to a user when announcing a particular user interface element. For example, an element can be highlighted (e.g., with an arrow, a border or some other visual effect) contemporaneously with the announcing of the element. The highlighting is intended to indicate where the element being announced is currently located on the display. Visually impaired users, however, may not be able to easily perceive where the element is located on the display using the visual cue.

Some systems provide visual cues designed to enable vision-able users to identify particular user interface elements. For example, some systems include techniques that allow a user to easily identify where a mouse cursor is within a display. Such techniques are particularly useful with large displays, small cursors or under low-visibility condition. For example, the mouse cursor can be flashed, temporarily enlarged or rendered during motion with contrails (mouse tails). Although these effects can be useful, these visual effects are is still dependent on a user's visual perception.

### SUMMARY

Systems, apparatus, methods and computer program products are described below for using surround sound to audibly describe the user interface elements of a graphical user interface. The position of each audible description is based on the position user interface element in the graphical user interface. The details of which are described below in full.

In one aspect a method is provided that includes identifying one or more user interface elements that have a position within a display space. Each identified user interface element is described in surround sound, where the sound of each description is positioned based on the position of each respective user interface element relative to the display space.

One or more implementations can optionally include one or more of the following features. The display space can be a currently focused window. The display space can be an entire graphical user interface. The method can include receiving user input to control the identification. Each user interface element can be associated with a description. The description of each user interface element can be visually rendered with each respective user interface element. The method can include translating the description associated with each identified user interface element into sound using text-to-speech where the description includes a character string. The method can include identifying user interface elements automatically. The method can include identifying elements from left to right at a particular vertical position. The method can include indicating that the particular vertical position has changed. The method can include indicating that the next identified element is left of the previously identified element. The method can include indicating that the element has been described. The method can include presenting new user interface elements in the display space; and automatically identifying one or more of the new user interface elements. The method can include presenting a cursor in the display space highlighting the user interface element that is currently being described. Each user interface element can have a depth, where the depth of each user interface element based on a front-to-back ordering of user interface elements of the display space. The method can include identifying audio volume for presentation of the description of each user interface element based on the depth of each respective user interface element. The method can include filtering the presentation of each user interface element's description based on the depth of each respective user interface element. Filtering the presentation of a user interface element occluded by another element can cause the presentation to sound muffled.

In another aspect a method is provided that includes, in response to user input, identifying a user interface elements having a position within a display space. A sound is generated in surround sound, the position of the sound based on the position of the a user interface elements within the display space.

One or more implementations can optionally include one or more of the following features. The user interface element can be a mouse cursor. The user input can include moving the mouse cursor.

In another aspect a method is provided that includes, identifying a first portion of a graphical user interface. The identified portion of the graphical user interface contains a plurality of user interface elements. For each user interface element in the plurality of user interface elements: 1) a position of the user interface element is identified within a second portion of the graphical user interface, 2) a description for the user interface element is identified, and 3) a presentation of the description is positioned in surround sound, where the positioning is based on the identified position.

One or more implementations can optionally include one or more of the following features. The second portion of the graphical user interface can be the window containing the user interface element. The second portion of the graphical user interface can be the entire graphical user interface. Identifying a description can include converting a textual description associated with the user interface element into audio using text-to-speech.

Particular embodiments of the subject matter described in this specification can be implemented to realize one or more of the following advantages. Announcing elements using positional audio allows users who are vision impaired to quickly receive position information during each user interface element announcement. A visual cursor highlighting an element that is being announced helps able-sighted users determine which element is being announced. Additional auditory cues indicate the order and progress of user interface element announcements. A positional audio cue that reflects the position of the mouse cursor allows users to easily perceive the location of the mouse cursor even in low visibility conditions.

### DESCRIPTION OF DRAWINGS

FIG. 1A is an illustration of an exemplary graphical user interface.

FIG. 1B is an illustration of a user viewing the GUI in FIG. 1A.

FIG. 2 is a flow diagram of a process for audibly describing user interface elements.

FIG. 3 illustrates a system for presenting a positional audio description of a user interface element.

Like reference numbers and designation in the various drawings indicate like elements.

### DETAILED DESCRIPTION

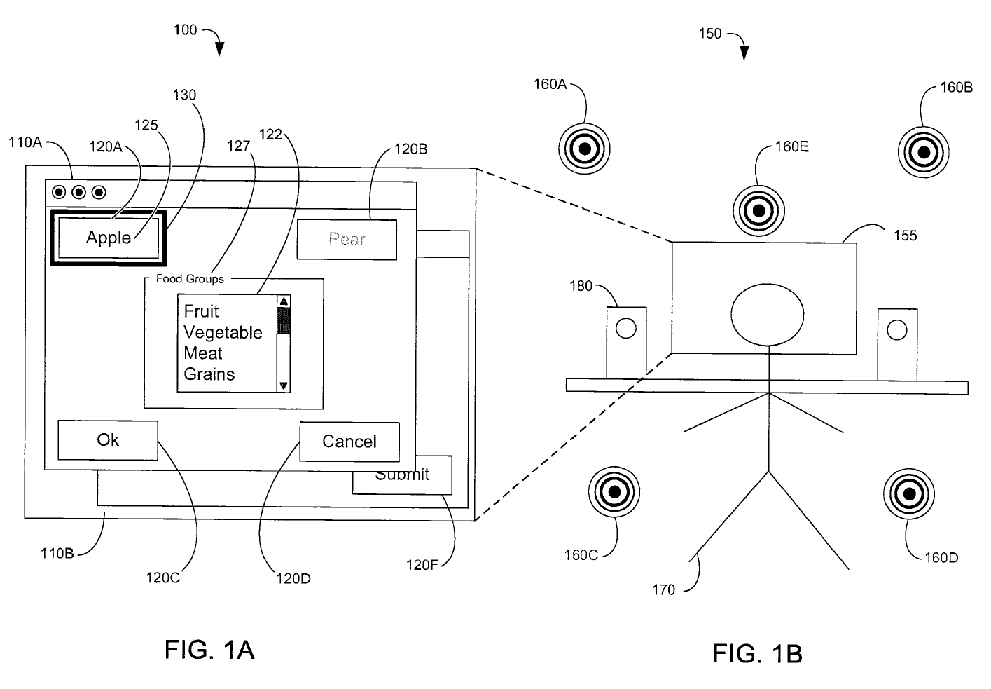

FIG. 1A is an illustration of an exemplary graphical user interface (GUI) 100. The GUI 100 can include several windows 110, where each window can represent a respective application, folder, file, data element or process. In general, one of the several windows can be active. An active window is a window representing the application that a user of the GUI is currently interacting with. The active window typically, although not always, overlaps other windows in the GUI that are not active.

Each window in the GUI 100 can include multiple interface elements 120A-D and 122. In the implementation shown, each interface element 120 is exemplified as a button and each button 120A-D has a separate label 125. The interface element 120B is a dimmed button (e.g., disabled, inactive). The interface element 122 is a list box containing several selectable items, each item is represented by a label presented with the interface element 122. The interface element 122 is contained within a group box interface element 127. Each interface element has a visual representation in the GUI 100 and, in general, each interface element can be positioned anywhere in the GUI. In general, interface elements include, for example, input boxes, labels, buttons, list boxes, pull-down boxes (or combo boxes), expandable lists (e.g., a tree view for presenting a hierarchy of items) and others.

Some interface elements can be nested so that one element contains one or more other elements. For example, a window is a user interface element that can contain numerous other windows or other interface elements in general. A list box can contain multiple item labels that each represent the name of an item in the list box. For example, the list box 122 includes at least four nested elements representing each of the four items in list box 122. Typically, when nested elements are presented the nested interface elements are positioned within the geometric space bounded by the nesting element. For example, each button 120 is nested within the window 110 and each button is positioned within the area represented by the window.

In some implementations, each element can be visually emphasized or highlighted at different points in time (e.g., upon selection or activation). For example, the cursor 130 can be presented as an outline surrounding the element 120A. In other implementations, elements can be visually emphasized by other means. For example, the color of the element can be altered (e.g., highlighted, tinted, or flashed), the element can be temporarily enlarged (e.g., as if by a magnifying glass), the element can be pointed to by an arrow or can be emphasized by other visual techniques. A visually rendered cursor can be particularly useful for multiple concurrent users of varying sight capacity (e.g., a low-vision user collaborating with a fully sighted user).

An element 120A in the GUI 100 can be described audibly. In some implementations, an audible announcement describes a particular element based on information about the element including associated description information. For example, the element 120A can be described as “Apple”, based on the element's label, or “Apple Button”, based on the element's label and type. In some implementations, an element's audible announcement can be generated automatically using text-to-speech techniques. In general, several items in the GUI can be described audibly.

The user interface elements in the GUI can be announced in succession. For example, user input can be received to indicate that the elements in the active window should be audibly described. In response, each element in the window can be announced in succession. The order in which user interface elements are announced can be determined by the elements' spatial order in the windows (e.g., announced from left-to-right and top-to-bottom). Alternatively, the order can reflect an ordering that is associated with the element (e.g., specified by the user interface designer). The audible announcements describing user interface elements is typically of particular interest to users who suffer from visual impairment.

As shown in FIG. 1B, a user 170 may be viewing the GUI 100 on a display device 155. Speakers 180 can be used to present an audible description of user interface elements 120. Typically sound is produced from at least a left and a right speaker. In general, however, the particular configuration of speakers can vary significantly among implementations. For example, audible announcements can be produced from headphones, a pair of speakers, or three or more speakers (e.g., in configurations specified by the Quadraphonic, Dolby Prologic I/II/IIx, DTS, etc. surround sound processing specifications). Two or more speakers can be used to facilitate generating surround sound.

Surround sound (or as is sometimes referred to herein as “positional audio”) is sound that is perceived by a listener as having a spatial position or originating from a particular spatial location. Producing surround sound depends on the particular configuration of speakers. For example, sound that originates from a particular horizontal position can be easily achieved using two horizontally-oriented speakers (e.g., left and right). Sound that originates from a position behind the listener may depend on speakers being both in front and behind the listener. In some implementations, particular surround sounds can be mimicked using audio effects in lieu of ideal speaker configuration. For example, using only two horizontally-oriented speakers, sound depth can be mimicked using attenuation and reverb effects.

The sounds 160A-E represent the spatial location of particular sounds as perceived by the user 170. For example, the sound 160A is perceived by the user as originating from above and to the left of the user 170, while the sound 160D is perceived as originating from below and to the right of the user 170. The spatial origin of each sound 160 can also be positioned depth-wise relative to the user. For example, the sound 160C may also be perceived as originating behind, rather than in front, of the user 170.

The description of an element can be audibly announced to convey information about the element's spatial location within the GUI. In some implementations, the audible description of a particular element is presented so that it is perceived by a listener as originating from a particular direction and with respect to a particular depth. The direction and depth of the element's announced description can reflect the element's position within the GUI. For example, the listener 170, shown in FIG. 1B, hears the audible description of the element 120A as originating from the point 160A. The audible description of element 120B will be perceived as originating from point 160B. Thus, having heard the descriptions of both elements, the listener 170 is also able to determine that spatial relationship between both elements, namely that the element 120A is to the left and at a same depth as element 120B. The listener 170 can automatically determine the relative spatial position of each element from the direction and depth of the audible description of each element.

The direction and depth (i.e., the perceived origin) of the audible description of an interface element depends on the relative position of the user interface element. The relative position of the user interface element depends on the element's context with respect to other elements in the GUI. The position of an element's description, for example, can depend on the element's position with respect to the window that the element is contained in. In such implementations, the direction of the audible description of button 120D and the button 120F are the same because both buttons have the same position within their respective windows 110. Alternatively, each audible description can be conveyed with a varying depth to indicate that one element is behind the other (e.g., the button 120F is contained in a window that is behind the window containing the button 120D). In other implementations, the relative position of an element depends on the element's position with respect to the “entire” GUI 100. In one implementation, the “entire” GUI refers to the parts of the GUI that are visible at once, usually referred to as the GUIs display space (e.g., constrained by the limits of the display device on which the GUI is presented). In such implementations, the direction of the audible description of button 120D would be slightly to the left of the direction of the audible description for button 120F.

In some implementations the cursor 130 can be used to visually highlight each interface element as each element is audibly described. In some implementations, the cursor 130 can be moved after each announcement to the next user interface element in the active window, in effect following along with the announcement of multiple elements. For example, the cursor 130 can highlight the element 120A while the audible description of element 120A is announced. When the next element, for example element 120B, is announced, the cursor can be moved to highlight element 120B.

User interface elements can, in some implementations, be positioned within a GUI such that they are aligned in a grid-like fashion. For example, the elements 120A and 120B are aligned horizontally so that they have approximately the same horizontal position. In some implementations, announcement of each element can be ordered based on each element's position. Elements can be announced, for example, in a left-to-right, top-to-bottom fashion. For example, in the window 110A, the element 120A is announced before element 120B, which is announced before element 122. The ordering of the announcement can be preset or configured by the user.

In some implementations, an audible cue can be presented when the cursor 130 moves in a particular direction (e.g., vertically) or, alternatively, whenever the cursor 130 moves in more than one direction. For example, an audible cue can be presented when the cursor moves right and downwards from the element 120B to the element 122. The audible cue can be, for example, a ding, bell, beep or other sound effect (e.g., the sound of a typewriter bell). The audible cue provides further information to the user about the relative location of the cursor and element that is being announced. An audible cue can be particularly effective to indicate when the cursor has moved vertically, otherwise it may be taxing for listeners to rely on sound direction alone or when speaker configuration cannot be relied on to accurately produce ideal surround sound. For example, when a user has only two conventionally-oriented stereo speakers sound that varies by horizontal position is usually more easily discerned compared to sound that varies by vertical position.

In some implementations, an audible cue (e.g., an extra sound effect or modification of the announcing voice) can be used to designate other events that occur while announcing one or more user interface elements. In one implementation, an audible cue can be presented between presenting the description of each element. In other implementations, an audible cue can denote the state of an element (e.g., whether the element is dimmed, disabled, locked, or has focus). Presenting an audible cue between element descriptions can help listeners discern when the description of one element has ended and the next has begun.

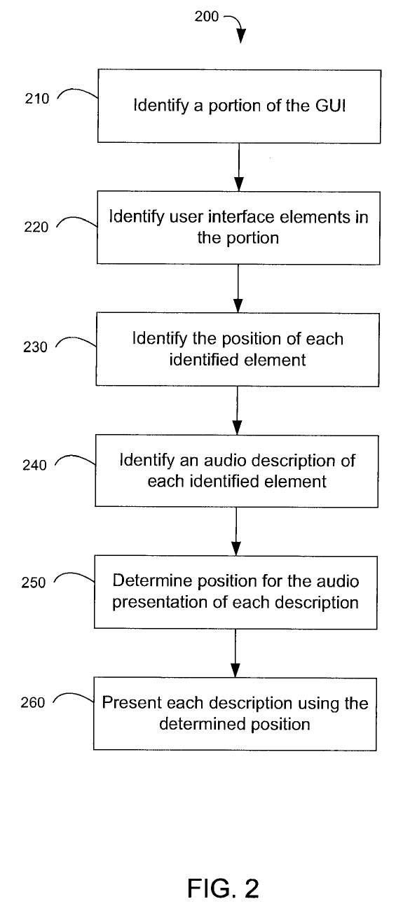

As shown in FIG. 2, a process 200 for audibly describing user interface elements includes identifying a portion of the GUI (step 210). In some implementations, the currently active window can be used to automatically identify a portion of the GUI that is equivalent to the area of the active window (e.g., in response to user input such as a keystroke, keystroke combination, mouse gesture, etc.). Alternatively, a user can select one or several user interface elements to identify a portion of the GUI. For example, a user can select a window (e.g., by clicking on it), which identifies user interface elements contained within the window. In some implementations, a particular element can be selected identifying a portion of the GUI that begins with the particular element. For example, in response to selecting a particular user interface element (e.g., the element 122 in FIG. 1A) all following elements, based on a left-to-right top-down ordering, are included in the identified portion (e.g., elements 120C and 120D). In some implementations, a portion of the GUI is identified based on the area of the GUI covered by the cursor. For example, the location of the cursor (e.g., the cursor 130 in FIG. 1A) can be determined in response to user input (e.g., by clicking on elements, or moving the location of the cursor using keystrokes). In response to each movement of the cursor, a new portion of the GUI is identified.

The process 200 includes identifying user interface elements within the identified portion (step 220). In some implementations, every element within the identified portion is identified (e.g., every visible element within the identified portion at any level of nesting). Alternatively, only the highest-level elements contained in the identified portion can be identified. For example, if a window is identified (in step 210), all high-level elements within the window can be identified. High-level elements are those elements that are directly nested within the window element, rather than another element. For example, referring to FIG. 1A, the elements 120A-D and 122 of window 110A can be identified, but not the nested elements within the list box 122 (e.g., the elements representing each item in the list). In some implementations, if the identified portion corresponds to an element (e.g., such as a window), the element itself can be included among the identified elements, in addition to other elements nested within the identified element (e.g., the window's elements).

In some implementations, user interface elements can be automatically identified based on when they are visually presented in the GUI. For example, when a window appears (e.g., a dialog box), user interface elements within the window can automatically be identified. In such implementations, any user interface element that appears or is otherwise made visible in the graphical user interface can be automatically identified. Alternatively, the user interface elements that are made active in the user interface can be automatically identified when they go active.

The process 200 includes identifying the position of each identified element (step 230). The position of a particular element is determined relative to other elements (e.g., relative to the parent element in which the particular element is nested). For example, the position of an element within a window can be identified by the element's horizontal and vertical position within the window. Alternatively, the position of a particular element is determined relative to the entire GUI. For example, the position of an element can be identified by the element's horizontal and vertical position within the display area of the GUI.

The process 200 includes identifying an audio description of each identified element (step 240). In some implementations, each identified element can be associated with an audio description. In other implementations, an audio description can be generated automatically based on information associated with the element. For example, each element can be associated with a textual description of the element and a type identifier. In another example, a user interface element can be associated with text (or an image) that is visually rendered, typically, with the user interface element (e.g., the label of a button). Other information associated with the identified element can also be used to generate an audio description (e.g., whether the element contains other elements or whether the element is editable, locked, enabled, or operable to receive user input).

The information associated with an element can be used to automatically generate an audio description of the element. In some implementations, the audio description can be generated from the element's associated information based on text-to-speech techniques. Text-to-speech techniques can be used to generate an audio description from textual information. For example, the element type and the element description for the element 120D, as shown in FIG. 1A, can be combined and used to generate an audio description, which reads: “Cancel button.” The audio description of element 120B can, for example, read “Pear dimmed button.” In some implementations, the description of one interface element can refer to the description of another interface element. For example, the interface element 122, the list box, can refer to the description of the group box interface element 127. The reference of the group box in the description of the list box can be used to generate a combined description for the list box interface element 122 such as “Food Groups list box.”

In some implementations, the information associated with a particular element can include information associated with elements that are nested within the particular element. For example, the information associated with a window can include information associated with buttons that are nested within the window. The information associated with nested elements can be used to generate a summary for the higher-level element (e.g., of the parent element). For example, the information associated with window 110A in FIG. 1, can include information about nested elements within window 110A, such as: “window 110A includes two buttons, a list box, which has four items, an okay button and a cancel button.” Alternatively, the list box 122 can be associated with the information referring to the items nested in the list box 122, such as “the list box 122 includes four items, fruit, vegetables, meat and grains.”

The process 200 includes determining the position or direction of the audio presentation for each identified element. The position of an audio presentation is identified by one or more audio production parameters. Each audio production parameter affects how the audio is presented to the user. The values of the audio production parameters affects the origin or direction of sound as perceived by the listener.

An azimuth parameter can indicate the horizontal position of the sound. The value of the azimuth parameter determines to what degree the audio sounds are perceived as originating from the left or the right of the listener. For a particular element, the value of the azimuth parameter can reflect the relative horizontal position of the element.

An elevation parameter can indicate the vertical position of the sound. The value of the elevation parameter determines to what degree the audio sounds are perceived as originating from above or below the listener. For a particular element, the value of the elevation parameter can reflect the relative vertical position of the element.

A diffusion parameter can indicate the whether the sound is diffuse or muffled. Diffuse sounds are perceived by the listener as originating far away or as if behind another object. For a particular element, the value of the diffusion parameter can reflect the element's position with respect to other elements in the GUI. In some implementations, the audio description of an element can be announced even if the element is not visible in the GUI. In particular, if the element is covered, occluded or obfuscated by another element (e.g., an overlapping window such as element 120F shown in FIG. 1), the audible description of the element can be made to sound muffled or diffuse, as though the audio is obstructed by the intervening window or element. In other implementations, a particular user interface element can have a depth identifying the number of other elements occluding the user interface element (e.g., the front-to-back order (or z-order) of one user interface element compared to other elements). The depth of the element can be used to determine the degree of diffusion.

An attenuation parameter can indicate the strength of the sound signal based on the distance of the sound's source to the listener. The value of the attenuation parameter will affect the loudness of the sound as perceived by the listener. For a particular element, the value of attenuation parameter can be adjusted based on the depth of the user interface element. For example, for two user interface elements where one element overlaps the other, the relative attenuation of each element's announcement indicates which element is overlapping. For example, the attenuation of the announcement of element 120D, in FIG. 1, can be higher than the attenuation of the announcement of element 120F. In other implementations, the attenuation value of an announcement can be based on the distance of an element to a user. A distance can be calculated based on a volumetric area of the GUI (e.g., height, width and depth) where the user is assumed to be centered in front of the GUI. For example, the announcement of list box 122 can have a higher attenuation than the announcement of the button 120C because the list box 122 is both front (e.g., zero depth) and center.

In some implementations, information about identified elements (e.g., position, textual information, audio description, audio production parameters, hierarchy or relationship with other elements) can be stored in a cache. The cache can contain some or all of the information necessary to present an audio description of elements in the GUI. The information related to an element can be identified within the cache rather than re-identifying or re-generating information that was previously identified or generated (e.g., audio descriptions or audio parameters). For example, if a second portion of the GUI is selected and an element is identified whose information is already in the cache, then the element's audio description, for example, can be used directly from the cache.

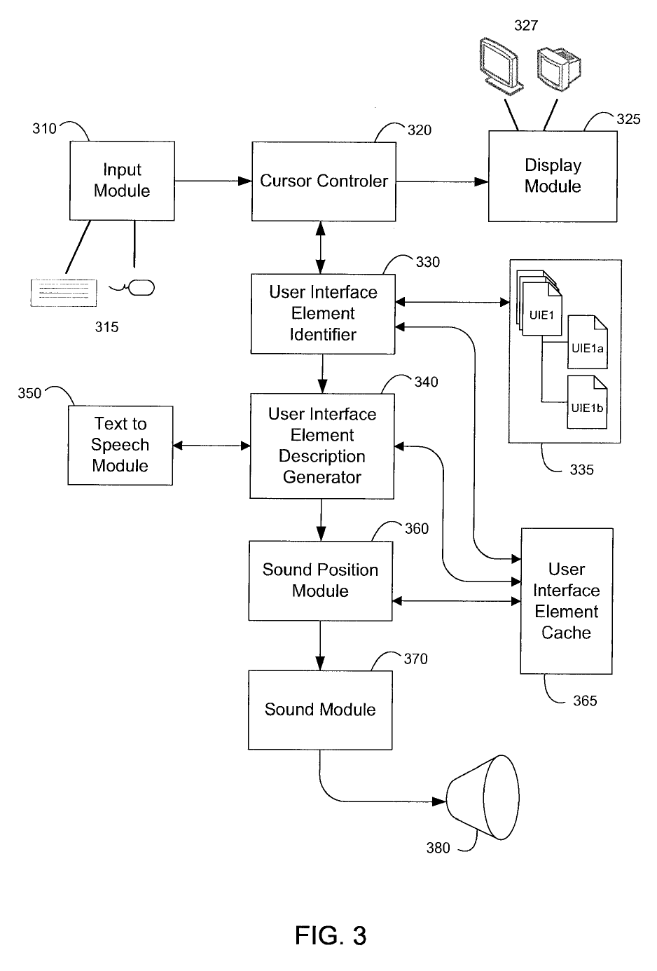

FIG. 3 shows an exemplary system 300 for presenting a positional audio description of a user interface element. The system 300 generally includes modules (e.g., modules 320-370) and resources (e.g., user interface element information 335). In one implementation, a module is typically a unit of distinct functionality that can provide and receive information to and from other modules. In some implementations, modules (e.g., display module 325) can facilitate communication with input or output devices (e.g., display devices 327). Modules can operate on resources. Generally, in one implementation, a resource is a collection of information that is operated on by a module. In some implementations, however, a module that provides information to another module can behave like a resource and vice-versa. For example, the user interface element cache 365 can, in some implementations, be considered a resource.

The system 300 includes an input module 310 for receiving user input from a user input device 315 (e.g., a keyboard, keypad, mouse, trackpad, touch-sensitive display, tablet, etc.). User input can be received by a cursor controller 320. The cursor controller 320 determines the location of the cursor used to indicate which user interface element is being announced. The cursor can have a visual representation that is presented by a display module 325 connected to one or more display devices 327 (e.g., a CRT display, an LCD display, or an embedded display).

In some implementations, the cursor that indicates which element is being announced (the VoiceOver cursor) is the same cursor that indicates which element currently has focus (hereafter referred to as the focus cursor). For example, the VoiceOver cursor identifies (e.g., surrounds, highlights) the same element as the focus cursor. A focus cursor is a common feature of many GUI systems and identifies that a particular element has focus (e.g., is selected or operable to further input). Generally, the focus cursor can be moved from one user interface element to another based on user input (e.g., a mouse click, a keystroke, or key combination) or in accordance with the instructions of a program or application being presented within the GUI. In such implementations, when a user interface element receives focus (e.g., focus cursor moves to the element), then the element is announced in response. Each element can be announced in turn in response to each movement of the focus cursor.

In other implementations, the VoiceOver cursor is not the same as the focus cursor (e.g., the VoiceOver cursor does not identify, surround or highlight the same element as the focus cursor). In such implementations the VoiceOver cursor can be made to identify a particular user interface independently of the focus cursor. The focus cursor is not changed by the movement or manipulation of the VoiceOver cursor. In general, the VoiceOver cursor can also be moved within the GUI (e.g., from one user interface element to another) based on user input or by a program or application being presented within the GUI.

The system 300 also includes a user interface identifier 330, which identifies user interface elements within the GUI or within a portion of the GUI (e.g., identifying the user interface elements nested within another element). The user interface identifier can read user interface element information from the user interface hierarchy 335, which describes each user interface element and each element's relationship with other elements. For example, the user interface element ‘UIE1’ may be a window element and may contain two other user interface elements, (e.g., ‘UIE1a’ is a button and ‘UIE1b’ is another button). User interface hierarchy 335 can, in some implementations, be accessible from the GUI system. For example, the Mac OS X® includes the Carbon AX application programming interface that can be used to interrogate the operating system about user interface elements currently being displayed.

In some implementations, the user interface identifier 330 identifies several user interface elements. As each element is identified the element's description can be audibly presented (e.g., based on the other parts of system 300, as described below). As each element is identified, the VoiceOver cursor can be moved (e.g., in conjunction with the cursor controller 320) to visually indicate which element is identified.

The system 300 can include a user interface description generator 340 that generates an audible description for each identified user interface element. In some implementations, each element can include an audible description (e.g., provided by the author of the element or the application of the element). In other implementations, information about each element can be used to generate a textual description of the user interface element (e.g., a description text field provided by the developer, the element type, status, etc.). The textual description of the user interface element is used to generate an audible description by a text-to-speech module 350. The text-to-speech module 350 generates audio from a text string whereby presentation of the audio sounds like a vocalization of the text string.

The system 300 can include a sound positioning module 360, which determines the value of audio parameters used to position the presentation of the element s audible description. The sound positioning module 360 can determine the value of audio parameters based on the position of the element with respect to the entire GUI or one or more other user interface elements or the user or other reference point. Other information about each element can also be used to determine the value of audio parameters. For example, the diffusion audio parameter can be determined based on whether the element is partly or completely obscured by another user interface element in the GUI.

In some implementations, some or all of the information identified or provided by the modules in system 300 can be stored or recorded temporarily in a user interface element cache 365. The user interference element cache 365 can contain information about user interface elements, the element's audible description, audio parameters, etc. User interface information, if available, in the user interface element cache 365 can be accessed in lieu of determining or generating the information from other sources (e.g., from the user interface hierarchy 335 or the text-to-speech module 350). Using the cache 365 to temporarily store information related to user interface elements can simplify and expedite presenting the audible description of a particular user interface element.

The system 300 can include a sound module 370, which is used to present the audible element description. The sound module 370 can be, in some implementations a sound generation module, such as the Core Audio API for Mac OS X®. In some implementations, the sound module 370 can present the audible description based on information about the configuration of speakers 380 to which the sound module provides information to produce sound. For example, the sound module 370 may present an audible description differently for stereo speakers compared to stereo headphones or a five-speaker surround-sound configuration.

In some implementations, the sound module 370 can use other audio processing effects to affect the presentation of an element's audible description. For example, a reverberation effect can be used to add a reverberating acoustic quality to the sound being presented. Adding reverberation to positioned sound can improve the perception of depth and help listeners to differentiate between sounds that have different positions.

In general, modules and resources illustrated in the system 300 can be combined or divided and implemented in some combination of hardware or software on one or more computing devices connected by one or more networks.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, i.e., one or more modules of computer program instructions encoded on a computer readable medium for execution by, or to control the operation of, data processing apparatus. The computer readable medium can be a machine readable storage device, a machine readable storage substrate, a memory device, a composition of matter effecting a machine readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

In another example, in some implementations, the identified user interface element can be a cursor in the GUI. The cursor's position is changed in response to user input. An audibly positioned cue can be presented in response to each change of the cursor. For example, in response to user input affecting the position of the mouse cursor, an audible cue can be presented as the mouse cursor moves. The position of the audio presentation corresponds to, and indicates to the listener, the position of the mouse relative to the GUIs display space.

What is claimed is:

1. A method comprising:
identifying one or more user interface elements having a position within a display space; and
describing each identified user interface element in surround sound, the sound of each description being positioned based on the position of each respective user interface element relative to the display space.

2. The method of claim 1, where:
the display space is a currently focused window.

3. The method of claim 1, where:
the display space is an entire graphical user interface.

4. The method of claim 1, further comprising:
receiving user input to control the identification.

5. The method of claim 1, where:
each user interface element is associated with a description.

6. The method of claim 5, where:
the description of each user interface element is visually rendered with each respective user interface element.

7. The method of claim 5, further comprising:
translating the description associated with each identified user interface element into sound using text-to-speech, the description including a character string.

8. The method of claim 1, further comprising:
identifying user interface elements automatically.

9. The method of claim 8, further comprising:
identifying elements from left to right at a particular vertical position.

10. The method of claim 9, further comprising:
indicating that the particular vertical position has changed.

11. The method of claim 9, further comprising:
indicating that the next identified element is left of the previously identified element.

12. The method of claim 9, further comprising:
indicating that the element has been described.

13. The method of claim 8, further comprising:
presenting new user interface elements in the display space; and
automatically identifying one or more of the new user interface elements.

14. The method of claim 1, further comprising:
presenting a cursor in the display space highlighting the user interface element that is currently being described.

15. The method of claim 1, where:
each user interface element has a depth, the depth of each user interface element based on a front-to-back ordering of user interface elements of the display space.

16. The method of claim 15, further comprising:
identifying audio volume for presentation of the description of each user interface element based on the depth of each respective user interface element.

17. The method of claim 15, further comprising:
filtering the presentation of each user interface element's description based on the depth of each respective user interface element.

18. The method of claim 17, where:
filtering the presentation of a user interface element occluded by another element causes the presentation to sound muffled.

19. A method comprising:
in response to user input, identifying a user interface element having a position within a display space; and
generating a sound in surround sound, the position of the sound based on the position of the user interface element within the display space.

20. The method of claim 19, where:
the user interface element is a mouse cursor.

21. The method of claim 19, where:
the user input includes moving the mouse cursor.

22. A method comprising:
identifying a first portion of a graphical user interface, the identified portion of the graphical user interface containing a plurality of user interface elements; and
for each user interface element in the plurality of user interface elements:
identifying a position of the user interface element within a second portion of the graphical user interface;
identifying a description for the user interface element; and
positioning in surround sound a presentation of the description, the positioning based on the identified position.

23. The method of claim 22, where:
the second portion of the graphical user interface is the window containing the user interface element.

24. The method of claim 22, where:
the second portion of the graphical user interface is the entire graphical user interface.

25. The method of claim 22, where identifying a description, includes:
converting a textual description associated with the user interface element into audio using text-to-speech.

26. A computer program product, encoded on a computer-readable medium, operable to cause a data processing apparatus to:
identify one or more user interface elements having a position within a display space; and
describe each identified user interface element in surround sound, the sound of each description being positioned based on the position of each respective user interface element relative to the display space.

27. A computer program product, encoded on a computer-readable medium, operable to cause a data processing apparatus to:
in response to user input, identifying a user interface element having a position within a display space; and
generating a sound in surround sound, the position of the sound based on the position of the user interface element within the display space.

28. A computer program product, encoded on a computer-readable medium, operable to cause a data processing apparatus to:
identify a first portion of a graphical user interface, the identified portion of the graphical user interface containing a plurality of user interface elements; and
for each user interface element in the plurality of user interface elements:
identify a position of the user interface element within a second portion of the graphical user interface;
identify a description for the user interface element; and
position in surround sound a presentation of the description, the positioning based on the identified position.

29. A system comprising:
means to identify one or more user interface elements having a position within a display space; and
means to describe each identified user interface element in surround sound, the sound of each description being positioned based on the position of each respective user interface element relative to the display space

30. A system comprising:
in response to user input, means to identify one or more user interface elements having a position within a display space; and
means to generate a sound in surround sound, the position of the sound based on the position of the one or more user interface elements within the display space.

31. A system comprising:
means to identify a first portion of a graphical user interface, the identified portion of the graphical user interface containing a plurality of user interface elements; and
for each user interface element in the plurality of user interface elements:
means to identify a position of the user interface element within a second portion of the graphical user interface;
means to identify a description for the user interface element; and
means to position in surround sound a presentation of the description, the positioning based on the identified position.
